(19) United States
(12) Patent Application Publication
(10) Pub. No.: US 2007/0137943 A1
(43) Pub. Date: Jun. 21, 2007

(54) Pendulum actuated gearing mechanism and power generation system using same

(76) Inventor: Paul Duclos, Iles De La Madelaine (CA)

Correspondence Address: AKERMAN SENTERFITT, P.O. BOX 3188, WEST PALM BEACH, FL, 33402-3188, US

(21) Appl. No.: 10/533,986

(22) PCT Filed: Sep. 3, 2004
(86) PCT No.: PCT/CA04/01628

§ 371 Date: Dec. 4, 2006

Related U.S. Application Data
(60) Provisional application No. 60/500,020, filed on Sep. 5, 2003.

(51) Int. Cl. F03G 3/00

(52) U.S. Cl. 185/27

(57) ABSTRACT

A mechanism and method for driving a generator comprising at least one pendulum comprising a mass free to pendulate about an axis of oscillation along a path of travel, an actuator for applying a force to the mass in a direction of pendulation for at least a portion of the pendulation and a drive train between the at least one pendulum and the generator for transferring energy between the pendulum and the generator.

### FIELD OF THE INVENTION

The present invention relates to a pendulum actuated gearing mechanism and power generation system using same. In particular, the present invention relates to a mechanism and method for converting a reciprocal movement into a rotational movement in order to actuate a device such as a generator.

### BACKGROUND OF THE INVENTION

Using the momentum of a pendulum as a way of producing work has been known for centuries. What has changed is the means for maintaining the pendulum swing as well as the means to convert a substantially linear movement into a movement more readily adaptable for producing useful work.

The prior art discloses an apparatus for harnessing the energy derived from the undulatory motion of a body of water including: a pendulum assembly having a buoyancy sufficient for maintaining it afloat in the water, a first structure substantially following multidirectional undulatory motions of the water and second structure mounted in the assembly for free movement in a plurality of planes with respect to the first structure. The second structure is displaceable by gravity and by forces derived from the movement of the first structure. There is further provided in the prior art a device connected to the first and second structures for generating a pressure output in response to the force derived from the relative motions between the first and second structures. An arrangement is coupled to the pressure output of the device for utilizing, at lease indirectly, the energy derived from the pressure output.

The prior art also discloses an energy generator including a pendulum suspended at one end and in operative relationship with an external power device which imparts oscillation movements to the pendulum. The pendulum includes a weight disposed at one end and in operative cooperation with a hydraulic fluid cylinder to increase the hydraulic pressure of the fluid within the cylinder. A power output device receives the high pressure hydraulic fluid and generates output power. A second embodiment is directed to a power booster wherein energy is transferred between a pendulum and a power generating device.

Also, the prior art discloses a prime mover that stores mechanical energy in case of an electrical failure. When an electrical failure occurs, the prime mover is activated either manually or automatically by a computer with a battery back-up. The prime mover oscillates back and forth in a pendulum-like fashion which in turn drives an electrical generator in order to produce electricity. The prime mover comprises a base, elements that are rotatably mounted to the base, a pick-up balance that is rotatably mounted to the base and a drive that operatively connects the prime mover to the electrical generator.

### SUMMARY OF THE INVENTION

In order to address the disadvantages of the prior art, there is disclosed a mechanism for driving a generator. The mechanism comprises at least one pendulum comprising a mass free to pendulate about an axis of oscillation along a path of travel, an actuator for applying a force to the mass in a direction of pendulation for at least a portion of the pendulation and a drive train between the at least one pendulum and the generator for transferring energy between the pendulum and the generator.

There is also disclosed a mechanism for driving a driveshaft. The mechanism comprises at least two pendulums, wherein successive ones of the pendulums have an angular velocity that is substantially 180°/N out of phase where N is the number of pendulums, and a drive train between the pendulums and the driveshaft for transferring energy between the pendulums and the driveshaft.

Also, there is disclosed a drive train for transferring energy between a pendulum and a drive shaft. The drive train comprises a driving member mounted to the pendulum for pendulation therewith, a wheel and a freewheeling clutch mechanism interposed between the wheel and the drive shaft such that the drive shaft is driven only in a predetermined direction of rotation. The driving member applies a reciprocating rotational force to the wheel when pendulating. The rotating wheel drives the drive shaft.

Additionally, there is disclosed a system for generating electricity. The system comprises a generator, at least one pendulum comprising a mass where the mass is free to pendulate about an axis of oscillation, an actuator for applying a force to the mass in a direction of pendulation for at least a portion of the pendulation and a drive train between the pendulum and the generator for transferring energy between the pendulum and the generator.

Furthermore, there is disclosed a method for driving a generator. The method comprises the steps of providing at least one pendulum comprising a mass free to pendulate about an axis of oscillation, applying a force to the mass in a direction of pendulation for at least a portion of the pendulation, interconnecting a drive shaft with the generator such that the generator rotates therewith, and converting the pendulation into a rotational movement using a drive train, the drive train rotating the driveshaft in a predetermined direction of rotation.

### BRIEF DESCRIPTION OF THE DRAWINGS

FIG. 1 is an orthogonal view of a power generating system using a pendulum actuated gearing mechanism in accordance with an illustrative embodiment of the present invention;

FIG. 2 is a top plan view of a power generating system using a pendulum actuated gearing mechanism in accordance with an illustrative embodiment of the present invention;

FIGS. 3A through 3D provide graphs representing the force applied to a drive shaft by one or more pendulums via a drive train in accordance with illustrative embodiments of the present invention;

FIG. 4A is a sectional view along 4A-4A in FIG. 2 of a drive train in accordance with an illustrative embodiment of the present invention;

FIG. 4B is a perspective view along 4B-4B in FIG. 2 of drive members in accordance with an illustrative embodiment of the present invention;

FIGS. 5A through 5C provide alternative methods for converting the swing of a pendulum into rotational motion for driving a drive shaft in accordance with three alternative illustrative embodiments of the present invention;

FIG. 6 is a functional diagram of the method of operation of the drive train of FIG. 4;

FIG. 7 is an orthogonal view of an actuator in accordance with an illustrative embodiment of the present invention;

FIGS. 8A through 8D provide schematic diagrams of actuators in accordance with alternative illustrative embodiments of the present invention;

FIG. 9 is a schematic diagram of an electricity generating assembly in accordance with an alternative illustrative embodiment of the present invention;

FIG. 10 provides a top plan view of a power generating system using a pendulum actuated gearing mechanism in accordance with an alternative illustrative embodiment of the present invention, and

FIG. 11 provides a side view of the power generating system along 11-11 in FIG. 10.

### DETAILED DESCRIPTION OF THE ILLUSTRATIVE EMBODIMENTS

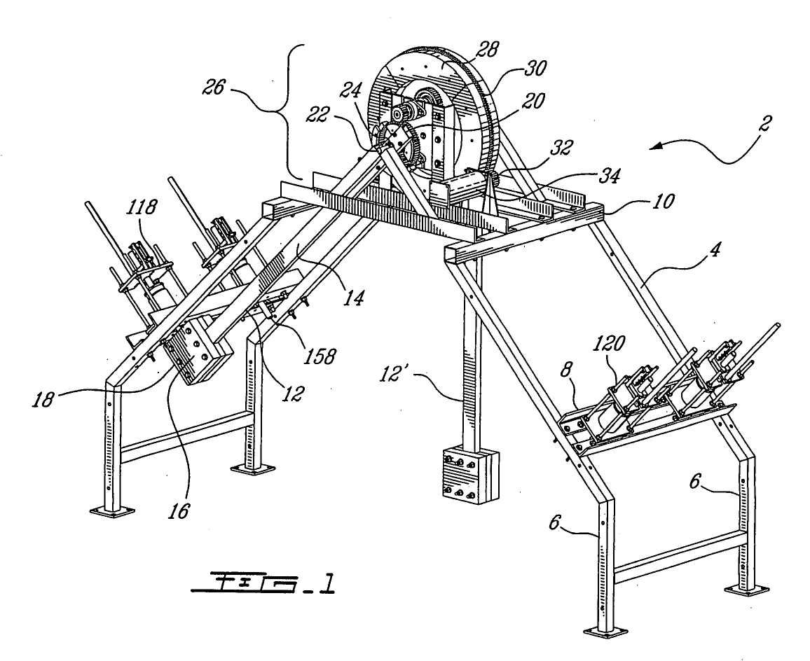

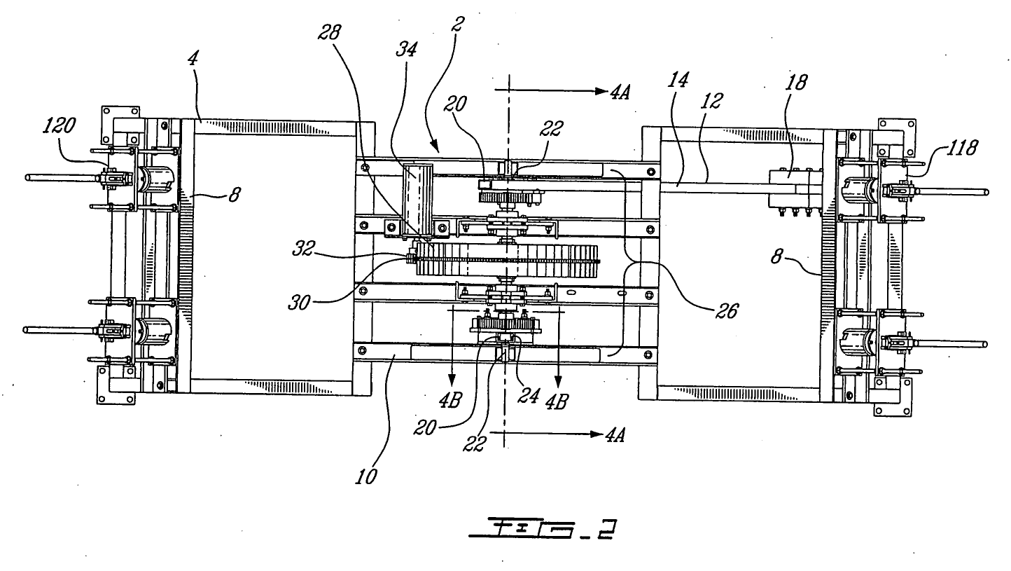

Referring now to FIGS. 1 and 2, a pendulum actuated gearing mechanism, generally referred to using the reference numeral 2, in accordance with an illustrative embodiment of the present invention will now be described. The mechanism 2 is comprised of a frame 4, manufactured for example from structural steel, of four legs as in 6 providing clearance above the ground for a pair of actuator supporting structures as in 8 and a drive train supporting structure 10. Cross braces (not shown) are also provided to improve structural integrity. A pair of pendulums 12, 12′ are included, each comprised of a rod 14 with a relatively heavy mass 16 attached towards a first end 18 of each rod 14. Note that although the present illustrative embodiment discloses a pair of pendulums 12, 12′, a mechanism which incorporates a single or three or more pendulums is also foreseen a being within the scope of the present invention. The rod 14 of each pendulum 12 is secured towards a second end 20 to a pivot shaft 22, for example using a low friction sealed bearing 24 or the like, and around which the pendulum 12 is free to pivot.

The reciprocating motion of the pendulums 12, 12′ is translated into a rotational motion by a drive train 26 which is used to drive a flywheel 28. In the present illustrative embodiment the flywheel 28 is free to rotate about an axis of rotation and is comprised of a large toothed disk 30 via which it is operationally connected to a gear 32 which rotates therewith to drive an electrical generator 34. The generator 34 in turn produces an electric current when rotated.

Given the positioning of the mass 16 and drive train 26 to the pivot shaft 22, it will now be apparent to a person of ordinary skill in the art that the gearing mechanism 2 takes advantage of the leverage effect to concentrate the force brought to bear on the drive train 26 by the pendulation of the masses 16.

As is known in the art the period T square (T²) of a simple pendulum is proportional to the length L between the axis of oscillation and the centre of the bob, or mass. The following functions can be used to approximate the interrelationship of period and length:
T²=K·L (1)

$$\begin{matrix}K = \frac{g}{4 {π}^{2}} & ( 2 ) \\ T = 2 π \sqrt{\frac{L}{g}} & ( 3 )\end{matrix}$$

where g is the acceleration due to gravity.

In the case at hand the period T of the pendulum 12, 12′ swings will remain substantially constant provided the distance between the centre of the mass 16 and the axis of oscillation, in the case at hand the pivot shaft 22, is approximately the same and the angle through which the pendulums 12, 12′ pendulate is relatively small. As a result, if the pendulums 12, 12′ are initially out of phase by a predetermined angle it is assumed they will remain out of phase by this angle. However, in practice, given uneven loading on the pendulums 12, 12′ (such as bearing friction and the like) the period of each of the pendulums 12, 12′ is typically slightly different and over the long term and the pendulums will swing slowly in and out of phase. Additionally, as the angle through which the pendulums 12, 12′ pendulate increases their motion becomes less harmonic and as a result, during each period, the pendulums 12, 12′ may swing slightly in and out of phase for larger angles of pendulation. As a result, if it is wished to ensure that the motion of the pendulums remains out of phase at a predetermined angle, an additional mechanism which maintains this relationship may be included. This can be done, for example, using a suitable phase angle maintaining mechanism between the pendulums (not shown), a variety of which, such as cranks and the like, are known in the art. Alternative mechanisms for maintaining said phase relationship are also discussed hereinbelow at paragraph [042].

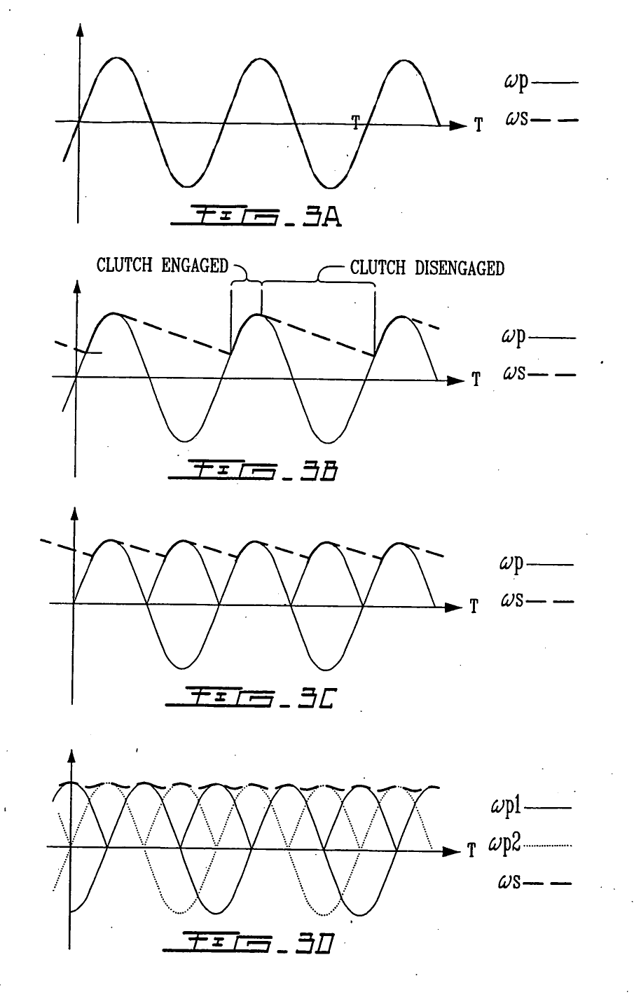

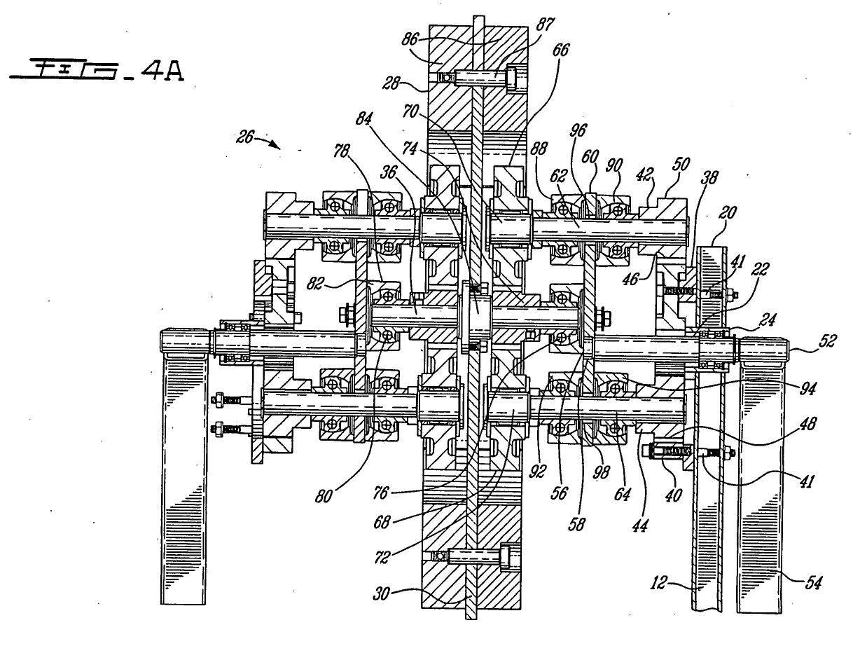

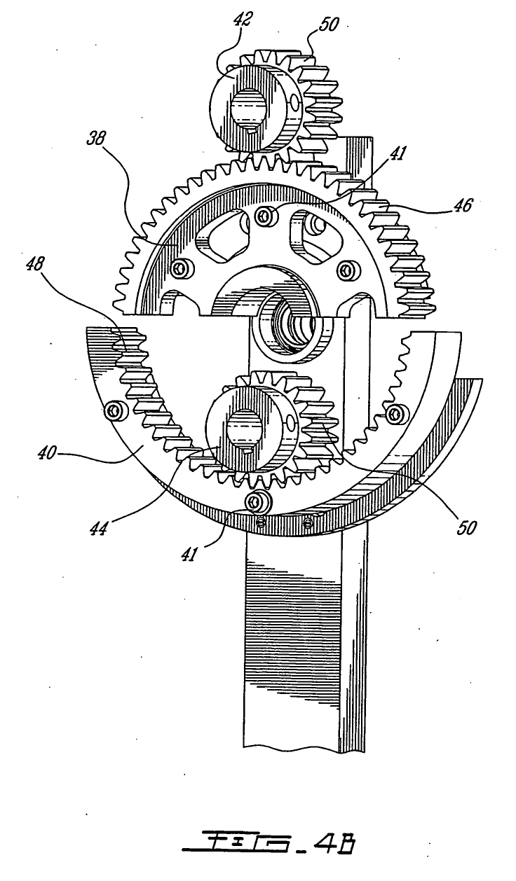

It will be apparent to a person of ordinary skill in the art that the pendulum reaches its maximum angular velocity (or rotational velocity) ω_{P} when the mass reaches its lowest point. It will also be apparent to a person of ordinary skill in the art that, during its period of pendulation, the angular velocity ω_{P} of the pendulum varies between this maximum angular velocity and zero, with the direction of angular velocity reversing at the end of each half period. It will also be apparent that where the angle of pendulation is small, the angular velocity ω_{P} of the pendulum is roughly sinusoidal, or harmonic. It will also be apparent that a shaft attached to the pendulum at the axis of oscillation will have the same characteristic of angular velocity ω_{S}. An example of the angular velocities ω of such a pendulum and shaft where the pendulum is acting as a simple pendulum are illustrated by the graph in FIG. 3A.

By interposing a freewheeling clutch which engages when a positive drive is applied, but disengages when the drive is negative (i.e. when the drive speed is less than the current speed, or in the reverse direction) between the pendulum and the shaft, the force imparted to the shaft by the pendulum can be limited to that portion of the half period of the pendulum during which the clutch is engaged (the forward direction). At other times, in particular when the direction of pendulation of the pendulum is reversed, the clutch will disengage the shaft, thereby allowing it to freewheel. As a result, the angular velocity ω_{S} of the shaft will be the same or greater than the angular velocity of the pendulum ω_{P} in a forward direction and will tend to slow down (due to loading on the shaft) as the pendulum travels in the reverse direction and the shaft freewheels. As a result, the shaft will always spin in the same direction of rotation. An example of the angular velocities of such a pendulum and shaft where the pendulum is acting as a simple pendulum are illustrated in the graph of FIG. 3B. The speed at which the freewheeling shaft slows down can be reduced, thereby providing a more regular angular velocity ω_{S}, by attaching a flywheel having a relatively large moment of inertia to the shaft.

By interposing a gear between the pendulum and the shaft which reverses the direction of the angular velocity of the pendulum, and interposing a freewheeling clutch between the gear and the shaft, a force can be applied to the shaft in the direction of rotation as the pendulum travels in the reverse direction. By combining a mechanism that imparts force on the shaft in the direction of rotation as the pendulum travels in a forward direction with a mechanism that imparts force on the shaft in the direction of rotation as the pendulum travels in a reverse direction, the angular velocity ω_{S} of the shaft can be further maintained, especially when increased loads are applied to the shaft. The angular velocities of such a pendulum and shaft are illustrated in the graph of FIG. 3C where the pendulums 12, 12′ are acting as simple pendulums.

By adding a second pendulum which has a motion which is, for example, 90° out of phase with that of the first pendulum, combined with the same gearing and freewheeling clutches as discussed in the previous paragraph, the force applied to the shaft can be further regularized. The angular velocities of two such pendulums ω_{P1} and ω_{P2} and shaft ω_{S} are illustrated in the graph of FIG. 3D.

Similarly, by adding a third pendulum, combined with the same gearing and freewheeling clutches as discussed in the previous paragraph, and adjusting the period of the respective pendulums so that their motion is, for example, about 60° out of phase, the force applied to the shaft can be further smoothed. Additional pendulums can be added, and further smoothing of the force applied to the shaft achieved, provided the period of the respective pendulums is adjusted so that they are 180°/N out of phase, where N is the number of pendulums.

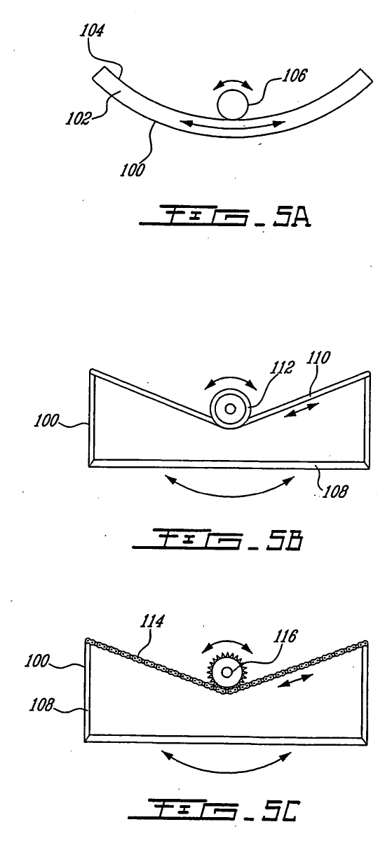

Referring now to FIGS. 4A and 4B, an illustrative embodiment of a drive train 26 for imparting force to a drive shaft 36 in accordance with the above principles will now be described. Each drive train 26 is comprised of upper and lower driving members 38, 40 securely mounted towards a second end 20 of the pendulum 12, for example by nut and bolt assemblies as in 41. The driving members 38, 40 each drive independent wheels, or pinions, 42, 44 in a reciprocating manner when the pendulum 12 is pendulating. In the illustrated embodiment, the upper driving member 38 is a rack having a curved dentated outer surface 46 and the lower driving member 40 is a rack having a curved dentated inner surface 48. The dentated surfaces 46, 48 drive the wheels (or pinions) 42, 44, illustratively having outer dentated surfaces as in 50 which mesh with the dentated surfaces 46, 48 of their respective driving members 38, 40. The radius of the curved dentated surfaces 46, 48 shares a common centre with the pivot shaft 22.

As discussed above, the pendulum 12 swings about the pivot shaft 22 on a sealed bearing 24 or the like. Each pivot shaft 22 is supported at a first end 52 by a support 54 and at a second end 56 by a hole 58 machined into a supporting plate 60 into which the second end 56 of the pivot shaft 22 is inserted. The supporting arm 54 and supporting plate 60 are manufactured, for example, from structural steel and form part of the drive train supporting structure (reference 10 in FIG. 1).

It will now be apparent to a person of ordinary skill in the art that the pinions 42, 44 rotate in opposite directions during oscillations of the pendulum 12. Each of the pinions 42, 44 is securely mounted on one end of a reciprocating shaft as in 62, 64 while cogs 66, 68 having integral freewheeling clutches 70, 72 are mounted at the other end of the reciprocating shafts 62, 64. The cogs 66, 68 in turn drive an additional cog 74 which is securely mounted to the drive shaft 36.

The drive shaft 36 is suspended between bearing mechanisms 76, 78, for example comprising a sealed bearing 80 held securely within a mount 82. The mount 82 is secured to the support plate 60 which, as discussed above, forms part of the drive train supporting structure (reference 10 in FIG. 1). In this manner the drive shaft 36, and therefore the toothed disk 30 to which the shaft is secured by a collar assembly 84 and flywheel 28, is supported and free to rotate around the axis of the drive shaft 36. The flywheel 28 is further comprised of a series of large weights as in 86 which are attached to both surfaces of the toothed disk 30 by means of an appropriate fastening means such as threaded bolts as in 87.

The reciprocating shafts 62, 64 are each supported towards their centres by pairs of bearing mechanisms 88, 90 and 92, 94 which are mounted coaxial with and on opposite sides of a hole as in 96, 98 machined in the supporting plate 60. The bearing mechanisms 88, 90, 92, 94 are mounted to the supporting plate 60 using appropriate fastening means such as nuts and bolts (not shown). Each of the bearing mechanisms 88, 90, 92, 94 is comprised, for example of a sealed bearing which fits snugly around the reciprocating shafts 62, 64 and rotates therewith. The combination of the bearing mechanisms 88, 90, 92, 94 and the holes 96, 98 allow the reciprocating shafts 62, 64 to rotate freely about their axis.

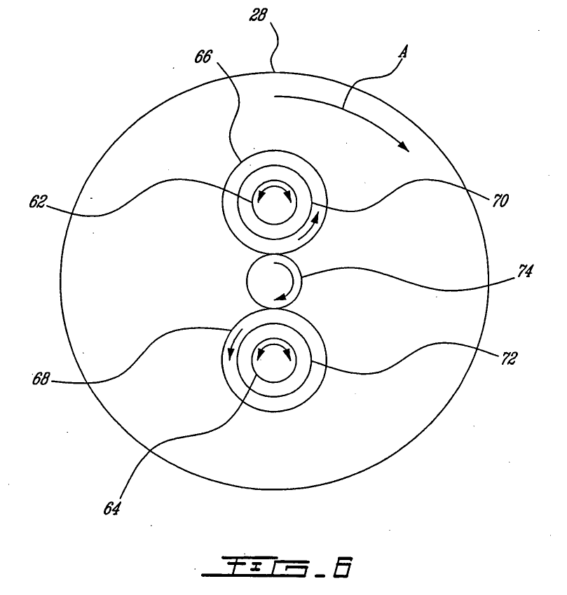

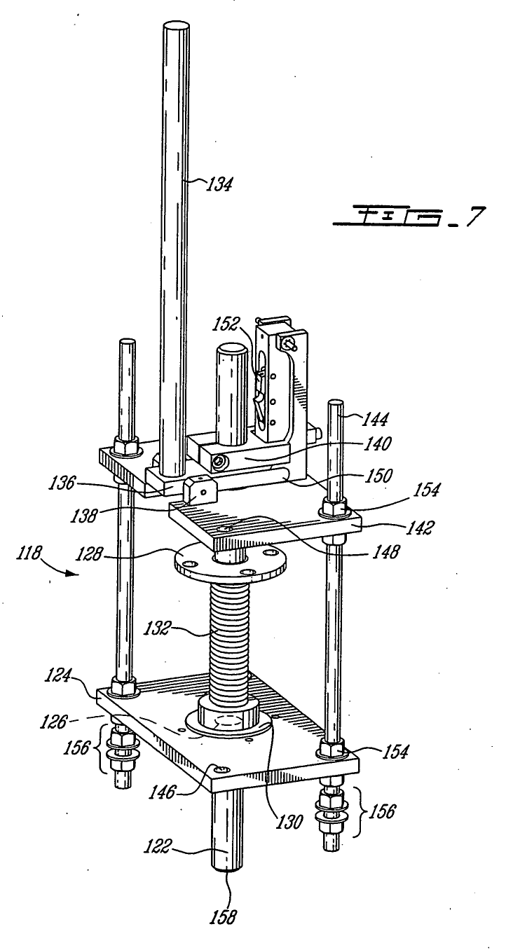

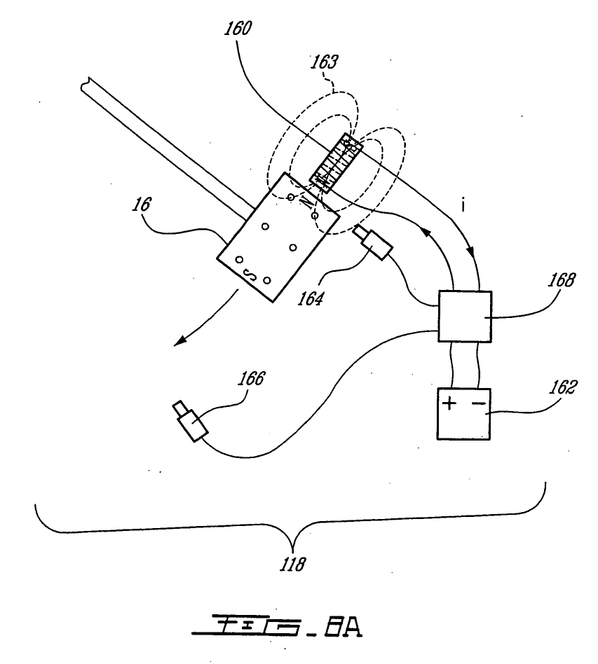

Note that, although in the above illustrative embodiment driving members 38, 40 are provided as racks which drive pinions 42, 44 other mechanisms for providing an equivalent transfer of energy between a pendulum and shaft can be foreseen. For example, referring to FIG. 5A, drive member 100 could be comprised of a rigid member 102 mounted to the pendulum (not shown) having a rough drive surface 104 driving a rubberized wheel 106 or the like. Alternatively, referring to FIG. 5B drive member 100 could be comprised of a structure 108 mounted to the pendulum (not shown) supporting a belt 110 or the like which is wound around a capstan 112. Similarly, referring to FIG. 5C drive member 100 could be comprised of a structure 108 supporting a chain 114 which drives a sprocket 116 positioned, for example, in line with the

Referring now to FIG. 6, in order to drive the flywheel 28 in a clockwise direction (as indicated by the arrow A on the flywheel 28) via additional cog 74 and drive shaft (reference 36 on FIG. 4A), cogs 66, 68 must rotate in a counter clockwise direction. As reciprocating shafts 62, 64 are being directly driven by the reciprocating movements of their respective driving members (references 38, 40 on FIG. 4A) the freewheeling clutches 70, 72 ensure that the cogs 66, 68 are engaged only during that portion of their rotation that the angular velocity of their respective reciprocating shafts 62, 64 in a counter clockwise direction would exceed their angular velocity.

Referring now back to FIGS. 1 and 2, it will be apparent to a person of ordinary skill in the art that each mass 16 in the present illustrative embodiment follows an arced path. The masses 16 of the pendulums 12, 12′ are driven by actuators as in 118, 120 which apply a force to the masses 16 in their direction of travel along their respective paths of pendulation, thereby maintaining the reciprocating motion of the pendulums 12, 12′. Note that although the present illustrative embodiment provides for a pair of actuators 118, 120 to drive each mass 16, a single actuator could be used in a given embodiment. Additionally, the actuators 118, 120 in the present illustrative embodiment apply force at the ends of the path of travel over a limited distance, although in a given embodiment it would be possible to apply force to the masses 16 at any point along the path of travel or, for example, over the entire path (provided, of course, that the force is applied in the direction of pendulation).

Note that the force imparted to each mass by the actuators as in 118, 120, can also be adjusted to maintain the pendulums in a predetermined phase relationship, for example by sensing the phase angle between pendulums and feeding this to a controller (not shown) which drives the actuators 118, 120. This can be used in addition to, or in replacement of, the phase angle maintaining gearing mechanism as discussed hereinabove at paragraph [028].

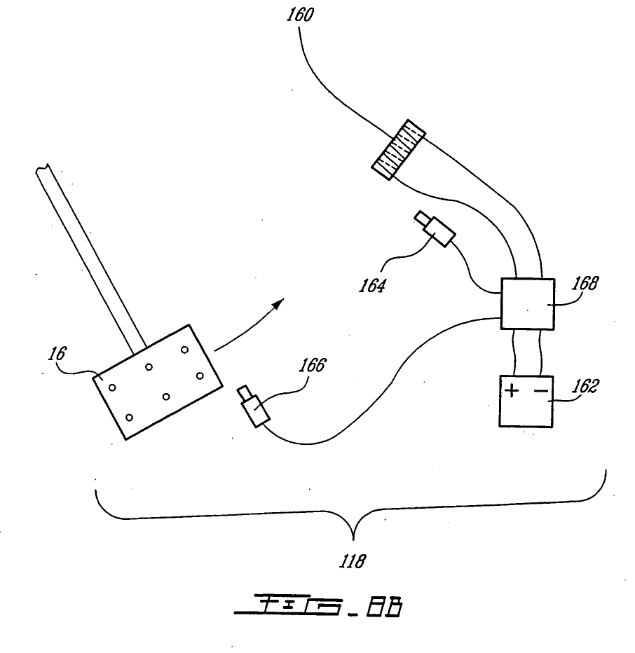

Referring now to FIG. 7, an actuator 118 in accordance with an illustrative embodiment will now be described. The actuator 118 is comprised of a piston rod 122 which is moveable along its axis through a base plate 124 within which a hole 126 has been bored between a cocked position and a released position (position as shown). A first spring collar 128 is attached to the piston rod 122 and moves therewith. A second spring collar 130 is securely fastened to the base plate 124. A spring 132 encircling the piston rod 122 is mounted at one end to the first spring collar 128 and at the opposite end to the second spring collar 130. As the piston rod 122 is moved from the released position to the cocked position the spring 132 is stretched. A hollow expandable sleeve (not shown) may also mounted between the base plate 124 and the first spring collar 128 to ensure that sand, water or other foreign matter does not foul or otherwise inhibit the movement of the piston rod 122 and spring 132.

Still referring to FIG. 7, in order to move the piston rod 122 into the cocked position from the released position, a cocking mechanism comprised of a hand operated lever, comprised of a handle 134, lever 136, hinge 138 around which the lever 136 pivots and a collar 140 attached to the piston rod 122 is provided. The hinge 138 is mounted to a top plate 142 which in turn is held in secured displaced relationship to the base plate 124 by a series of rods as in 144 which are inserted through holes as in 146, 148 respectively bored in the base plate 124 and top plate 142. Pulling on the handle 134 causes the lever 136 to pivot about the hinge 138, thereby bringing the tines 150 of the lever 136 into contact with the collar 140 and forcing the collar 140 away from the top plate 142. Once the piston rod 122 has been raised via the collar 140 to the cocked position, a stop mechanism 152 is engaged thereby retaining the piston rod 122 in the cocked position.

Note that, although the above actuator has been described using a hand operated lever for moving the piston rod into the cocked position from the released position, a variety of other mechanisms are foreseeable. For example, the hand operated lever could readily be replaced by an electrically motivated solenoid, or a pneumatic or hydraulic piston, with provision of the requisite source of electricity, compressed gas or liquid under pressure and control thereof.

As stated above, the base plate 124 and top plate 142 are illustratively held apart using a series of rods as in 144 (note that the nearest rod has been removed to improve clarity). Illustratively, at least a portion of the outer surface of the rods 144 is threaded allowing nut and washer assemblies as in 154 to mount the rods 144 to both the base plate 124 and the top plate 142. The combination of a threaded rod and nut and washer assemblies also allows the distance between base plate 124 and top plate 142 to be adjusted. The actuators 118 are mounted to the actuator supporting structure (reference 8 in FIG. 1) also using nut and washer assemblies as in 156 thereby allowing the distance between the actuator 118 and actuator supporting structure 8 to be adjusted.

Referring now back to FIGS. 1 and 2 in addition to FIG. 7, using the nut and washer assemblies as in 156, the position of the lower end 158 of the piston rod 122 of each actuator as in 118, 120 is adjusted so that when the angular velocity of the pendulum 12, and therefore the speed of the mass 16, is approaching zero, the mass 16 strikes the lower end 158 of the piston rod 122. Striking the lower end 158 of the piston rod 122 drives the collar 140 upward, thereby disengaging the stop mechanism 152 and releasing the piston rod 122. As a result, the piston rod 122 is moved from the cocked position to the released position via the force exerted on the piston rod 122 by the stretched spring 132. In turn, the lower end 158 of the piston rod 122 exerts a force on the mass 16, therein transferring the energy stored in the spring 132 to the mass 16.

Note that although the mass 16 striking the piston rod 122 has illustratively been used to disengage the stop mechanism 152, other mechanisms for disengaging the stop mechanism, for example a triggering mechanism (not shown) in the path of the mass 16, an electrical relay with a solenoid, photodiode (also not shown), etc., could also be used with suitable modifications. Additionally, the above mechanisms could also be triggered under supervision of a microprocessor based controller (also not shown).

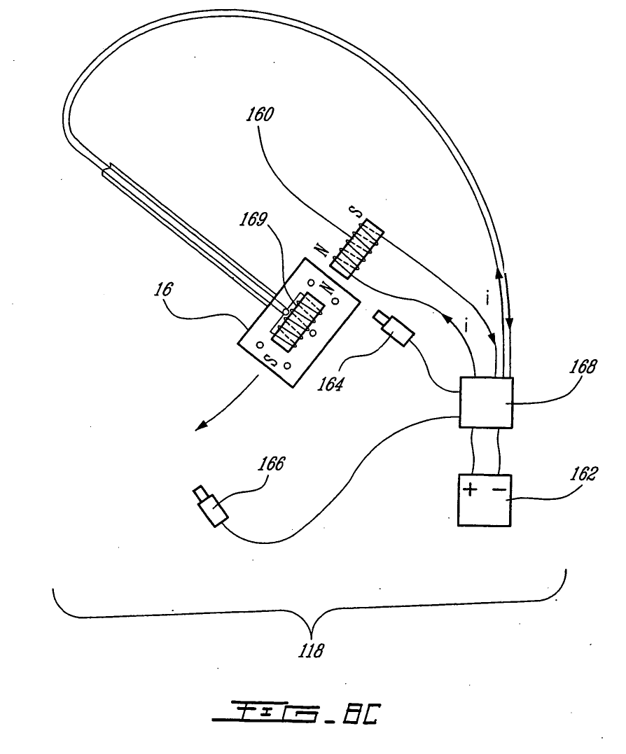

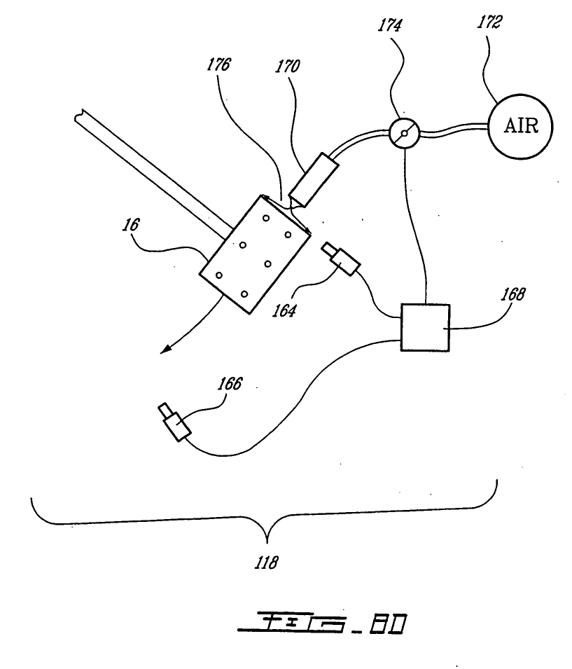

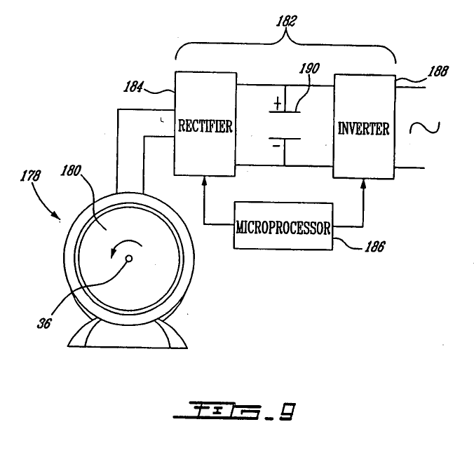

A variety of other mechanisms could also be used to provide the force generating characteristics of the actuators 118, 120. For example, referring to FIG. 8A, in an alternative embodiment the mass 16 is fabricated at least in part from a polarised magnetic material which forms a magnetic field (not shown), such as a bar magnet or the like, and the actuator 118 is be fabricated from a first series of one or more electro magnets 160, such as an iron core solenoid or the like. By supplying a direct current i to the electromagnets, for example via a battery 162, a polarised magnetic field 163 can be generated by the electro magnets 160 which can, depending on polarity, be used to attract or repel the mass 16. In order that the force of attraction or repulsion is applied to the mass 16 only over that portion of the path of travel where it is desired to accelerate the mass 16, a pair of sensors as in 164, 166 can be used to determine the position and direction of travel of the mass 16 along the path of oscillation and provide this information to a controller 168. The controller 168 would then supply electricity to the electromagnets 160 to either attract or repel the mass 16. The battery 162 can be charged, for example, in part from the output of the generator (reference 34 in FIG. 1) with provision, as necessary, of an appropriate power conversion and battery charging means (not shown).

Referring now to FIG. 8B, in a second alternative illustrative embodiment of an actuator 118, the mass 16 is manufactured from a ferrous material such as iron and the electromagnets 160 are excited via the controller 168 and battery 162 to produce a magnetic field which is used to attract the mass 16 over a portion of the path of travel of the mass 16. As in the example of FIG. 8A, a pair of sensors as in 164, 166 are used to determine the position and direction of travel of the mass 16 along the path of oscillation and provide this information to the controller 168.

Referring now to FIG. 8C, in a third alternative illustrative embodiment of an actuator 118, a second series of electro magnets 169, for example iron core solenoids, are integrated into the mass 16. Both series of electromagnets 160, 169 are excited with a direct current i via the controller 168 and battery 162 to produce polarised magnetic fields which are used to either attract and/or repel the mass 16 over a portion of the path of travel of the mass 16 (illustratively, a repelling force is shown in FIG. 8C). As in the example of FIG. 8A, a pair of sensors as in 164, 166 are used to determine the position and direction of travel of the mass 16 along the path of oscillation and provide this information to the controller 168.

Referring now to FIG. 8D, in a fourth alternative illustrative embodiment of an actuator 118, the electromagnets of FIGS. 8A and 8B are replaced by a nozzle 170 and source of compressed gas 172 such as compressed air. Using the outputs of position sensors 164, 166 as input, the controller 168 selectively opens and closes valves as in 174 which release streams of compressed air 176 providing a motive force applied to the mass 16 in the direction of pendulation.

Note, also, that it would also be possible to combine the above described actuator embodiments in a given implementation.

Referring back to FIGS. 1 and 2, in the embodiment in accordance with the present invention illustrated therein the generator 34 may be a DC generator, or a generator providing AC output having either one or three phases. These AC generators would typically be synchronous given that the pendulum period is relatively constant. However, asynchronous generators could also be used if it is intended to operate the system 10 at varying operational speeds (for example, by reducing the arc of oscillation at periods of low power).

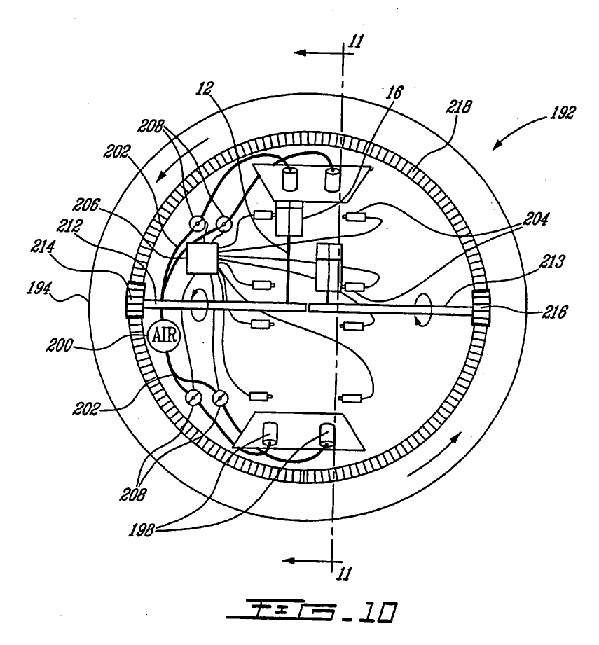

Note that, although the generator 34 as described is driven by the flywheel 28 via the toothed disk 30 and gear 32, it is within the scope of the present invention for the generator 34 to be driven directly by the drive shaft 36. For example, referring now to FIG. 9, a generator 178 having a rotor 180 directly connected to the drive shaft 36 is disclosed. For example, if the generator 178 is of the induction type (either 1 phase or 3 phase), rotation of the rotor 180 induces alternating current in the stator windings (not shown). Given that the revolutions per minute (RPM) of the drive shaft 36 is typically relatively low, a generator having multiple poles (not shown) could be used in order to produce an alternating current of a higher frequency than the speed of rotation. Additionally, and also alternatively, the alternating current output by the generator 178 could be input into a power conversion system 182 comprised of a rectifier 184, controlled by a microprocessor 186, for conversion into a direct current of constant voltage, and then inverted using an inverter 188 (also controlled by the microprocessor 186) to provide a steady synchronous sinusoidal output current of, for example, 60 Hertz. Additionally, a portion of the energy generated by the generator 178 and converted into DC by the rectifier could be stored in one or more batteries as in 190 for use during periods of high energy consumption.

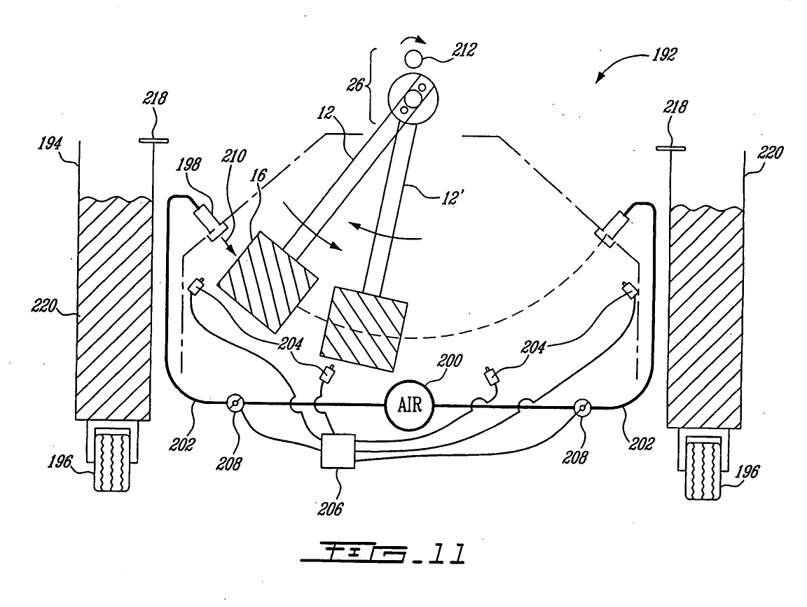

Referring to FIG. 10 and FIG. 11, a power generating system using a pendulum actuated gearing mechanism in accordance with an alternative illustrative embodiment of the present invention, and generally referred to using the reference numeral 192 will now be described. In this embodiment, the pendulums 12, 12′ and drive train 26 serve to drive an annular container 194 around an axis of rotation which is perpendicular to the ground. The annular container 194 is mounted on a series of wheels as in 196, for example rubber tires or steel wheels running on a circular steel track or the like (not shown). Illustratively, the pendulation of the pendulums is maintained by the actuating assembly described hereinabove with reference to FIG. 8D. A series of nobles as in 198 are interconnected with a source of compressed gas 200 such as compressed air via a network of hoses 202. Using the outputs of position sensors as in 204 as input, a controller 206 selectively opens and closes a series of valves 208 which release streams of compressed air 210 providing a motive force applied to the mass 16 in the direction of pendulation. The drive train 26 illustratively includes, for example, drive shafts 212, 213 which rotate a pair of cogs 214, 216 located towards the outer ends of the drive shafts 212, 213. The cogs 214, 216 in turn mesh with a dentated upper surface 218 of the annular container 194.

Still referring to FIGS. 10 and 11, pendulation of the pendulums 12 causes the drive shafts 212, 213 and cogs 214, 216 to rotate, thereby driving the annular container 194 in a rotary fashion around an axis of rotation. Additionally, as the annular container 194 beings to rotate at higher speeds it can be slowly filled with a heavy material 220, for example water mixed with sand or the like, using a pump or the like (not shown) thereby increasing the weight of the annular container 194 and as a result the amount of motive energy which can be stored in the system.

Although the present invention has been described hereinabove by way of illustrative embodiments thereof, these embodiments can be modified at will without departing from the spirit and nature of the subject invention.

What is claimed is:

1. A mechanism for driving a generator comprising:
at least one pendulum comprising a mass free to pendulate about an axis of oscillation;
an actuator for applying a force to said mass in a direction of pendulation for at least a portion of said pendulation; and
a drive train between said at least one pendulum and the generator for transferring energy between said pendulum and the generator.

2. The mechanism of claim 1, wherein the generator comprises a drive shaft and said drive train comprises a freewheeling clutch mechanism interposed between said pendulum and said drive shaft such that said drive shaft is driven only in a predetermined direction of rotation.

3. The mechanism of claim 1, wherein said pendulums have a periodic motion which is substantially harmonic.

4. The mechanism of claim 1, wherein the generator comprises a drive shaft and said drive train comprises:
a driving member mounted to said at least one pendulum for pendulation therewith;
a wheel, said driving member applying a reciprocating rotational force to said wheel when pendulating, said rotating wheel driving said drive shaft; and
a freewheeling clutch mechanism interposed between said wheel and said drive shaft such that said drive shaft is driven only in a predetermined direction of rotation.

5. The mechanism of claim 4, wherein said driving member comprises a rack and said wheel comprises a pinion.

6. The mechanism of claim 4, wherein said wheel comprises a capstan and said driving member comprises a belt wound around said capstan.

7. The mechanism of claim 4, wherein said wheel comprises a sprocket and said driving member comprises a chain.

8. The mechanism of claim 4, wherein said drive train further comprises a fly wheel interposed between said freewheeling clutch mechanism and said drive shaft.

9. The mechanism of claim 1, wherein the generator comprises a drive shaft and wherein said drive train comprises:
a first rack mounted to said at least one pendulum below said axis of oscillation for pendulation therewith;
a first pinion, said first rack applying a reciprocating rotational force to said first pinion when pendulating, said rotating first pinion driving said drive shaft, wherein a first freewheeling clutch mechanism is interposed between said first pinion and said drive shaft such that said drive shaft is driven only in a predetermined direction of rotation;
a second rack mounted to said at least one pendulum above said axis of oscillation for pendulation therewith; and
a second gear, said second rack applying a reciprocating rotational force to said second gear when pendulating, said rotating second gear driving said drive shaft, wherein a second freewheeling clutch mechanism is interposed between said second gear and said drive shaft such that said drive shaft is driven only in said predetermined direction of rotation;

10. The mechanism of claim 1, comprising two pendulums wherein said pendulums have an angular velocity which is substantially 90° out of phase.

11. The mechanism of claim 1, comprising a plurality of pendulums, wherein successive ones of said pendulums have an angular velocity which is substantially 180°/N out of phase and wherein N is the number of pendulums.

12. The mechanism of claim 1, further comprising a phase angle maintaining mechanism interposed between said pendulums.

13. The mechanism of claim 1, wherein said actuator is positioned at an end of said path of travel.

14. The mechanism of claim 1, wherein said actuator comprises:
a source of energy; and
a stop for controllably releasing said energy; and
wherein when said mass reaches a predetermined position along said path of travel, said stop is removed, thereby releasing said energy, said released energy being applied to said mass in a direction of pendulation.

15. The mechanism of claim 14, wherein said actuator further comprises a piston interposed between said source of energy and said mass, and wherein when said stop is released, said piston is conveyed by said source of energy from a cocked position to a released position.

16. The mechanism of claim 14, wherein said source of energy is a gas under pressure, said actuator further comprises a nozzle for directing said gas in a stream and wherein when said stop is released, said stream is directed by onto said mass.

17. The mechanism of claim 16, wherein said gas under pressure is compressed air.

18. The mechanism of claim 15, wherein said source of energy is a spring.

19. The mechanism of claim 15, wherein said source of energy is selected from the group consisting of elastic, pneumatic, hydraulic and magnetic.

20. The mechanism of claim 15, wherein said actuator further comprises a second source of energy for conveying said piston from said released position to said cocked position.

21. The mechanism of claim 20, wherein said second source of energy is a hand operated lever.

22. The mechanism of claim 20, wherein said second source of energy is an electrically activated solenoid.

23. The mechanism of claim 20, wherein said second source of energy is an pneumatically operated piston.

24. The mechanism of claim 20, wherein said second source of energy is a hydraulically operated piston.

25. The mechanism of claim 1, wherein said mass is fabricated from a ferrous material and said actuator comprises:
at least one electro magnetic; and
a source of electrical energy; and
wherein when said mass is travelling towards said electro-magnet and reaches a predetermined position along said path of travel, said source of electrical energy is applied to said electro magnets, thereby attracting said mass to said electromagnet.

26. The mechanism of claim 1, wherein said mass is fabricated from a magnetic material and said actuator comprises:
at least one electro magnet; and
a source of electrical energy; and
wherein when said mass is travelling away from said electro-magnet and reaches a predetermined position along said path of travel, said source of electrical energy is applied to said-electro magnets, thereby repelling said mass from said electromagnet.

27. The mechanism of claim 1, wherein said mass is fabricated from a magnetic material and said actuator comprises:
at least one electro magnetic; and
a source of electrical energy; and
wherein when said mass travelling towards said electromagnet reaches a predetermined position along said path of travel, said source of electrical energy is applied to said electro magnets, thereby attracting said mass to said electromagnet.

28. A mechanism for driving a driveshaft comprising:
at least two pendulums, wherein successive ones of said pendulums have an angular velocity that is substantially 180°/N out of phase and N is the number of pendulums; and
a drive train between said pendulums and the driveshaft for transferring energy between said pendulums and the driveshaft.

29. The mechanism of claim 28, comprising two pendulums, said two pendulums having angular velocities being substantially 90° out of phase.

30. The mechanism of claim 28, comprising three pendulums, successive ones of said three pendulums have angular velocities substantially 60° out of phase.

31. The mechanism of claim 28, further comprising a phase angle maintaining mechanism interposed between said pendulums, said phase angle maintaining mechanism maintaining the angular velocity of successive pendulums out of phase substantially at a predetermined phase angle.

32. A drive train for transferring energy between a pendulum and a drive shaft, the drive train comprising:
a driving member mounted to the pendulum for pendulation therewith;
a wheel, said driving member applying a reciprocating rotational force to said wheel when pendulating, said rotating wheel driving the drive shaft; and
a freewheeling clutch mechanism interposed between said wheel and said drive shaft such that the drive shaft is driven only in a predetermined direction of rotation.

33. The drive train of claim 31, further comprising a fly wheel interposed between said freewheeling clutch mechanism and said drive shaft.

34. The drive train of claim 31, wherein said driving member comprises a rack and said wheel comprises a pinion.

35. A system for generating electricity, the system comprising:
a generator;
at least one pendulum comprising a mass, said mass free to pendulate about an axis of oscillation;
an actuator for applying a force to said mass in a direction of pendulation for at least a portion of said pendulation; and
a drive train between said pendulum and said generator for transferring energy between said pendulum and said generator.

36. A method for driving a generator comprising the steps of:
providing at least one pendulum comprising a mass free to pendulate about an axis of oscillation;
applying a force to said mass in a direction of pendulation for at least a portion of said pendulation;
interconnecting a drive shaft with the generator such that the generator rotates therewith; and
converting said pendulation into a rotational movement using a drive train, said drive train rotating said driveshaft in a predetermined direction of rotation.

37. The method of claim 36, wherein said drive train comprises:
a driving member mounted to said pendulum for pendulation therewith;
a wheel, said driving member rotating said wheel when said pendulum is pendulating, said rotating wheel driving said drive shaft; and
a freewheeling clutch mechanism interposed between said wheel and said drive shaft such that said drive shaft is driven in said predetermined direction of rotation.
